(19) United States
(12) Patent Application Publication
(10) Pub. No.: US 2013/0305008 A1
(43) Pub. Date: Nov. 14, 2013

(54) MEMORY OPERATION TIMING CONTROL METHOD AND MEMORY SYSTEM USING THE SAME

(71) Applicant: SAMSUNG ELECTRONICS CO., LTD, Suwon-si (KR)

(72) Inventors: Jea-young Kwon, Seoul (KR); Shine Kim, Suwon-si (KR); Seong-jun Ahn, Seoul (KR); Woo-seok Chang, Seongnam-si (KR); Da-woon Jung, Hwaseong-si (KR)

(73) Assignee: Samsung Electronics Co., Ltd, Suwon-si (KR)

(21) Appl. No.: 13/836,595

(22) Filed: Mar. 15, 2013

(30) Foreign Application Priority Data
May 14, 2012 (KR) 10-2012-0051063

(51) Int. Cl. G06F 13/16

(52) U.S. Cl. CPC G06F 13/1689
USPC 711/167

(57) ABSTRACT

A method of controlling operation timing of memory devices included in a storage apparatus and a memory system including the method. The method includes adjusting operation timing such that a number of memory devices that simultaneously perform operations is below a reference value according to a host request, and issuing operations according to the adjusted operation timing and transferring the issued operations to the memory devices.

### CROSS-REFERENCE TO RELATED APPLICATIONS

This application claims priority under 35 U.S.C. §119(a) Korean Patent Application No. 10-2012-0051063, filed on May 14, 2012, in the Korean Intellectual Property Office, the disclosure of which is incorporated herein in its entirety by reference.

### BACKGROUND OF THE INVENTION

1. Field of the Invention

The present general inventive concept relates to a storage apparatus and a control method thereof, and more particularly, to a method of controlling operation timing of memory devices included in a storage apparatus and a memory system using the method.

2. Description of the Related Art

A solid state drive (SSD) that is a storage apparatus which uses a semiconductor as a storage medium promotes enhancement of performance by parallel processing a request of a host. The more the performance efficiency of the SSD is enhanced, the more the number of semiconductors that simultaneously perform operations in the SSD. This may cause a problem in that an operating temperature of the SSD increases higher than a guaranteed temperature.

### SUMMARY OF THE INVENTION

The present general inventive concept provides a memory operation timing control method of adjusting operation timing such that a storage apparatus may operate within a normal temperature range.

The present general inventive concept also provides a memory system to perform an operation within a normal temperature range by adjusting operation timing.

Additional features and utilities of the present general inventive concept will be set forth in part in the description which follows and, in part, will be obvious from the description, or may be learned by practice of the general inventive concept.

Exemplary embodiments of the present general inventive concept provide a memory operation timing control method including adjusting operation timing such that the number of memory devices that simultaneously perform operations is below a reference value according to a host request, and issuing operations according to the adjusted operation timing and transferring the issued operations to the memory devices.

The operation timing may be adjusted such that the number of the memory devices that simultaneously perform the operations for each of a plurality of channels is below a first threshold.

The operation timing may be adjusted such that the number of the memory devices that simultaneously perform the operations in all of the plurality of channels is below a second threshold.

The operation timing may include splitting the operations of the host request into one or more sub requests to have sizes capable of being processed by the memory devices.

The adjusting of the operation timing may include temporarily stopping the issuing of the operations with respect to a channel of the plurality of channels in which a number of banks that are performing operations exceeds a first threshold, and resuming the issuing of the operations with respect to a channel of the plurality of channels in which the number of the banks that are performing the operations is below the first threshold.

The adjusting of the operation timing may include temporarily stopping the issuing of the operations with respect to all of the channels in which a number of memory devices that are performing operations exceeds a predetermined threshold, and resuming the issuing of the operations with respect to all of the channels in which the number of the number of memory devices that are performing the operations is below the predetermined threshold.

The adjusting of the operation timing may include temporarily stopping the issuing of the operations with respect to all of the channels in which a number of memory devices that are performing operations exceeds a threshold, and resuming the issuing of the operations with respect to all of the channels in which the number of the number of memory devices that are performing the operations is below the threshold.

The adjusting of the operation timing may include, delaying a time taken to read the host request by an initially set time when the number of the memory devices that simultaneously perform the operations exceeds the reference value, and issuing operations based on the read host request according to the delayed time.

The memory operation timing control method may further include, detecting a temperature of a storage apparatus that includes the memory devices, where the operation timing is adjusted according to the detected temperature.

When the detected temperature exceeds a threshold temperature, a time taken to read the host request may be delayed by an initially set time, and operations may be issued based on the read host request according to the delayed time.

When the detected temperature exceeds the threshold temperature, the operation timing may be adjusted based on a scheduling operation of delaying the time taken to read the host request by an initially set time and a scheduling operation of limiting the number of the memory devices that simultaneously perform the operations is below a first threshold.

When the detected temperature exceeds a threshold temperature, a time taken to perform a write operation according to a host request is adjusted, and operations are issued based on the write host request according to the adjusted time.

When the detected temperature exceeds the threshold temperature, the operation timing is adjusted based on a scheduling operation of adjusting the time taken to perform a write operation according to the host request by an initially set time and a scheduling operation of limiting the number of the memory devices that simultaneously perform the operations is below a first threshold.

The memory operation timing control method may further include when the detected temperature exceeds the threshold temperature, reducing the reference value.

The memory operation timing control method may further include determining types of the operations to be issued to the memory devices, where the operation timing is adjusted when the determined types of the operations are write operations.

Exemplary embodiments of the present general inventive concept may also provide a memory system having memory devices including one or more channels and one or more banks, and a memory controller to issue operations to control the memory devices according to a request received from a host, when the memory controller adjusts operation timing such that the number of memory devices that simultaneously perform operations is below a reference value.

The memory system may further include a temperature sensor for detecting an operating temperature, where the memory controller performs at least one of a process of delaying a time taken to read the request by an initially set time when the temperature detected by the temperature sensor exceeds a threshold temperature and a process of adjusting the operation timing such that the number of the memory devices that simultaneously perform the operations for each channel is below the first threshold.

The memory controller may adjust the operation timing when types of the operations to be issued to the memory devices are write operations, and may not adjust the operation timing when types of the operations to be issued to the memory devices are not write operations.

Exemplary embodiments of the present general inventive concept also provide a method of controlling a storage device having a plurality of memory devices, the method comprising adjusting the timing of a plurality of operations performed by a memory controller of the storage device such that a number of the plurality of memory devices of the storage device that simultaneously perform the plurality of operations is below a predetermined value, issuing a plurality of time-adjusted operations with the memory controller according to the adjusted operation timing, where a number of issued time-adjusted operations correspond to the plurality of operations, and transferring the issued plurality of time-adjusted operations to the plurality of memory devices.

Exemplary embodiments of the present general inventive concept may also provide a storage apparatus comprising a plurality of memory devices having one or more channels and one or more banks, and a memory controller to issue one or more operations to control the plurality of memory devices at least according to a received request, and to adjust timing of the one or more operations that are issued such that a number of the plurality memory devices that simultaneously perform operations is below a reference value.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates a structural view of a memory system according to exemplary embodiments of the present general inventive concept;

FIG. 2 illustrates a structural view of a memory system according to exemplary embodiments of the present general inventive concept;

FIG. 3 is a diagram illustrating the structure of banks and channels of the memory system illustrated in FIGS. 1 and 2 according to exemplary embodiments of the present general inventive concept;

FIG. 4 is a diagram illustrating a detailed structure of a flash memory device illustrated in FIGS. 1 and 2 according to exemplary embodiments of the present general inventive concept;

FIG. 5 is a diagram illustrating a detailed structure of a memory controller illustrated in FIGS. 1 and 2 according to exemplary embodiments of the present general inventive concept;

FIG. 6 illustrates a memory operation timing control method performed by a memory controller illustrated in FIGS. 1 and 2 according to exemplary embodiments of the present general inventive concept;

FIG. 7 is a flowchart illustrating a memory operation timing control method according to exemplary embodiments of the present general inventive concept;

FIG. 8 is a detailed flowchart illustrating the memory operation timing control method of FIG. 7 according to exemplary embodiments of the present general inventive concept;

FIG. 9 is a detailed flowchart illustrating the memory operation timing control method of FIG. 7 according to exemplary embodiments of the present general inventive concept;

FIG. 10 is a detailed flowchart illustrating the memory operation timing control method of FIG. 7 according to exemplary embodiments of the present general inventive concept;

FIG. 11 is a flowchart illustrating a memory operation timing control method according to exemplary embodiments of the present general inventive concept;

FIG. 12 is a flowchart illustrating a memory operation timing control method according to exemplary embodiments of the present general inventive concept;

FIG. 13 is a flowchart illustrating a memory operation timing control method according to exemplary embodiments of the present general inventive concept;

FIG. 14 is a flowchart illustrating a memory operation timing control method according to exemplary embodiments of the present general inventive concept;

FIG. 15 illustrates an exemplary operation timing diagram for when the present general inventive concept is not applied;

FIG. 16 illustrates an exemplary operation timing diagram for when the present general inventive concept is applied;

FIG. 17 is a block diagram illustrating an example of an electronic apparatus including a memory system according to exemplary embodiments of the present general inventive concept;

FIG. 18 is a block diagram illustrating an example of an electronic apparatus including a memory system according to exemplary embodiments of the present general inventive concept; and

FIG. 19 is a block diagram illustrating an example of a network system including a memory system according to exemplary embodiments of the present general inventive concept.

### DETAILED DESCRIPTION OF THE PREFERRED EMBODIMENTS

The present general inventive concept will now be described more fully with reference to the accompanying drawings, in which exemplary embodiments of the present general inventive concept are shown. The present general inventive concept may, however, be embodied in many different forms and should not be construed as being limited to the embodiments set forth herein; rather, these embodiments are provided so that this disclosure will be thorough and complete, and will fully convey the concept of the inventive concept to one of ordinary skill in the art. It should be understood, however, that there is no intent to limit exemplary embodiments of the present general inventive concept to the particular forms disclosed, but conversely, exemplary embodiments of the present general inventive concept are to cover all modifications, equivalents, and alternatives falling within the spirit and scope of the inventive concept. In the drawings, like reference numerals denote like elements and the sizes or thicknesses of elements may be exaggerated for clarity of explanation.

The terminology used herein is for the purpose of describing particular embodiments and is not intended to limit the inventive concept. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless defined differently, all terms used in the description including technical and scientific terms have the same meaning as generally understood by one of ordinary skill in the art. Terms as defined in a commonly used dictionary should be construed as having the same meaning as in an associated technical context, and unless defined in the description, the terms are not ideally or excessively construed as having any formal meaning.

FIG. 1 illustrates a structural view of a memory system 100′ according to exemplary embodiments of the present general inventive concept.

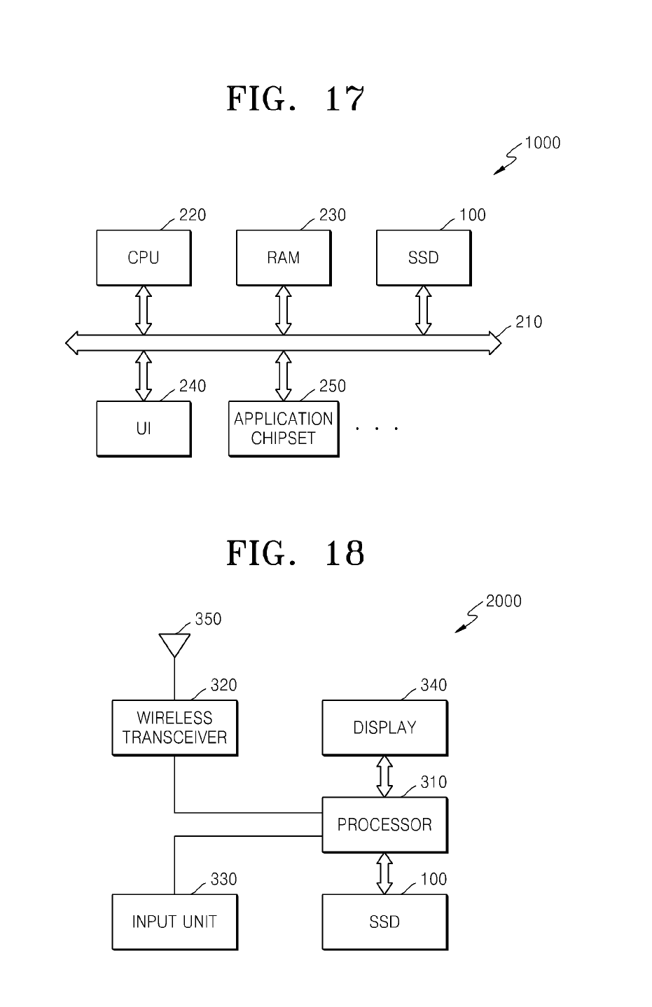

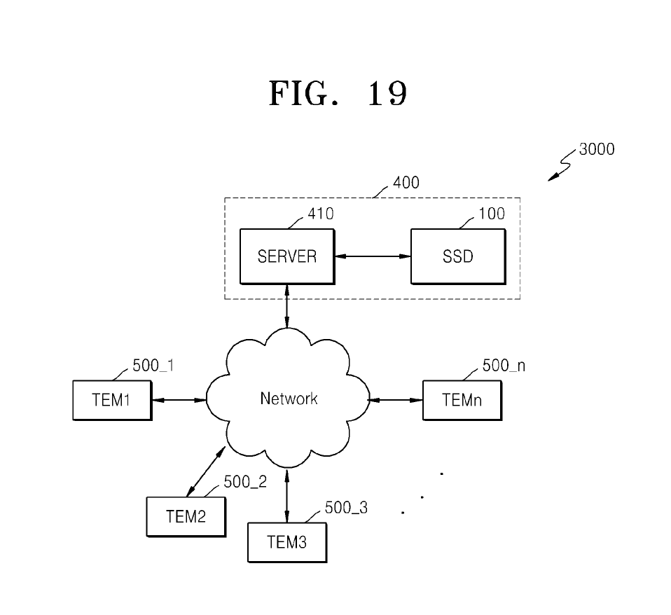

As illustrated in FIG. 1, the memory system 100′ includes a memory controller 110 and a storage apparatus 120. A host 10 may be communicatively coupled to the memory system 110′ (e.g., via the memory controller 110). The host 10 may be external to the memory system 100′. As illustrated in FIGS. 17 and 18, and discussed in detail below, the host may be part of an electronic apparatus (e.g., electronic apparatus 1000, electronic apparatus 2000, etc.). For example, the host may be a processor (e.g., central processing unit (CPU) 220 illustrated in FIG. 17, processor 310 illustrated in FIG. 18), an application chipset (e.g., application chipset 250 illustrated in FIG. 17), a server (e.g. a server 410 as illustrated in FIG. 19), a terminal (e.g., terminals 500_1 to 500_n illustrated in FIG. 19). The host 10 may provide a request to the memory system 100′, where the memory system will perform an erase, write, or read operation corresponding to the request of the host 10.

If the storage apparatus 120 is a non-volatile memory such as flash memory, the memory system 100′ may be a solid state drive (SSD). An SSD may also be referred to as a solid state disc.

FIG. 1 illustrates an example in which the storage apparatus 120 is includes flash memory devices 121 and 123. The example of FIG. 1 illustrates that four flash memory devices are combined for each channel (e.g., CH1 through CHN). As illustrated in FIG. 1, the flash memory devices 121 may include four flash memory devices that are communicatively coupled to the memory controller 110 via channel CH1, and the flash memory devices 123 may include four flash memory devices that are communicatively coupled to the memory controller 110 via channel CHN.

The storage apparatus 120 may include flash memory from among various types of non-volatile memory and various forms and types of memory devices may be applied thereto. For example, memory devices applied to the storage apparatus 120 may include a phase change random access memory (PRAM) device, a ferroelectric random access memory (FRAM) device, a magnetic random access memory (MRAM) device, etc., as well as a flash memory device. The storage apparatus 120 may include a combination of at least one non-volatile memory device and at least one volatile memory device, or may include a combination of two or more non-volatile memory devices.

The memory controller 110 may issue an operation to perform an erase, write, or read operation of the storage apparatus 120 in response to a request of the host.

Data input/output (I/O) between the memory controller 110 and the host may be configured in continuous logical address units. In this regard, I/O requested at a time may be defined as a request.

Channels may be formed between the memory controller 110 and the storage apparatus 120 to transfer signals to perform one or more operations. Examples of signals to perform the one or more operations may include commands, addresses, data, etc. Channels can be independent signal paths to transmit and receive signals between the memory controller 110 and the storage apparatus 120.

The memory system 100′ according to exemplary embodiments of the present general inventive concept may form one or more channels between the memory controller 110 and the storage apparatus 120. The example of FIG. 1 illustrates that an N (where N is a natural number) number of channels are formed. That is, FIG. 1 illustrates channels CH1 to CHN disposed between the memory controller 110 and the flash memory 121 and/or 123 of the storage apparatus 120.

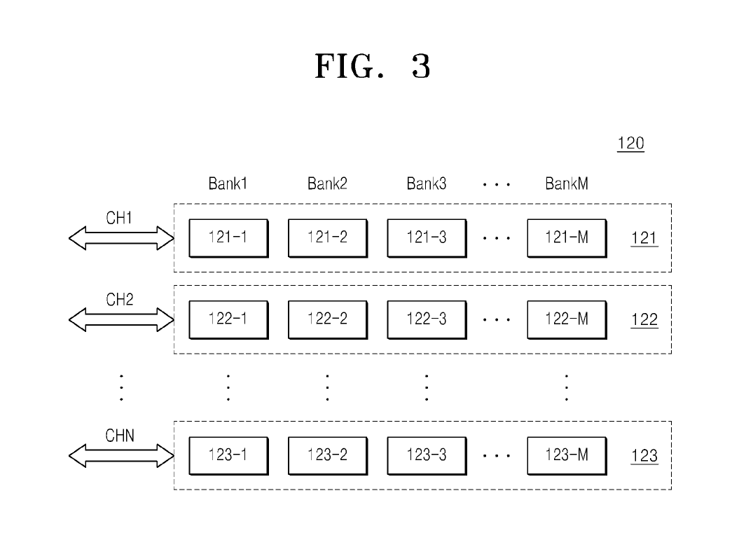

Each channel may include a plurality of banks (see, e.g., FIG. 3, which illustrates banks 121-1 to 121-M for CH1, banks 122-1 to 122-M for CH2, etc.). In this regard, a bank is a unit for identifying flash memory devices sharing the same channel. For reference, a bank may be referred to as a way. The detailed structures of channels and banks will be described below.

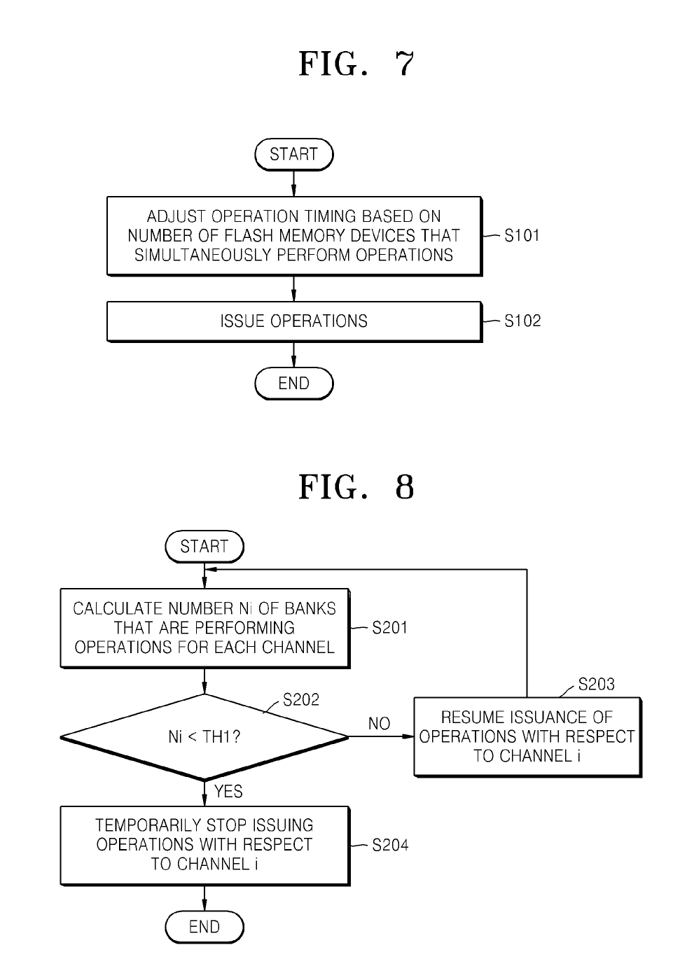

The memory controller 110 may perform a memory operation timing control method as illustrated in flowcharts of FIGS. 7 through 14. A detailed operation of the memory controller 110 will be described with reference to FIG. 3.

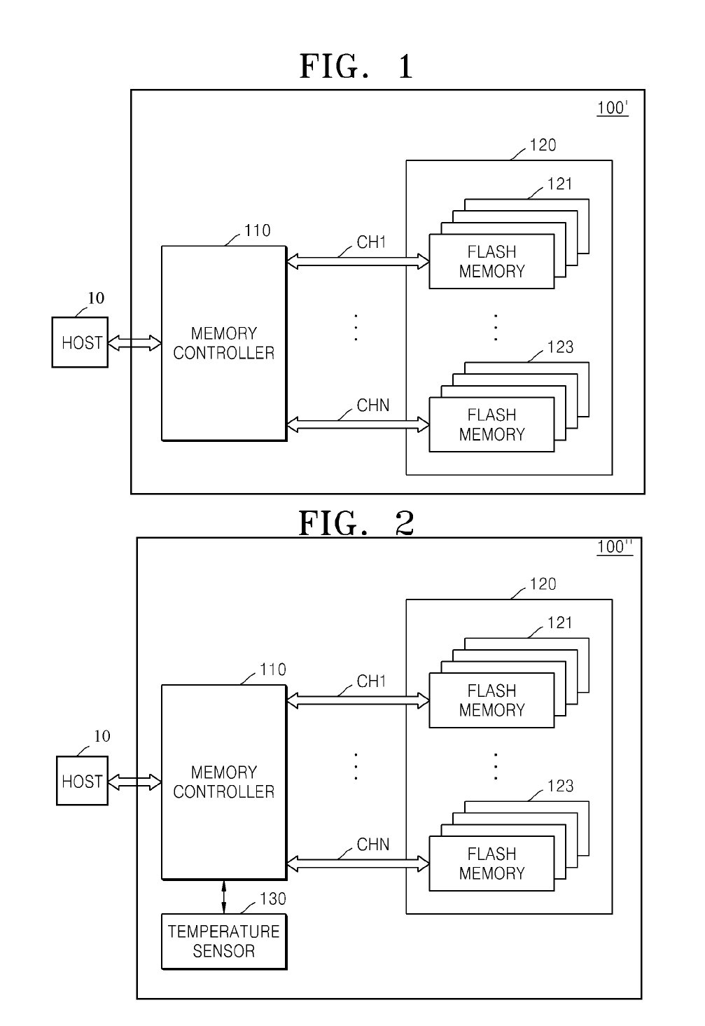

FIG. 2 illustrates a structural view of a memory system 100″ according to exemplary embodiments of the present general inventive concept.

As illustrated in FIG. 2, the memory system 100″ includes the memory controller 110, the storage apparatus 120, and a temperature sensor 130.

The memory system 100″ of FIG. 2 can include the temperature sensor 130, compared to the memory system 100′ of FIG. 1.

The temperature sensor 130 can detect an operating temperature of the memory system 100″. The temperature sensor 130 may be a temperature detection device such as a thermistor.

The memory controller 110 and the storage apparatus 120 have been described with reference to FIG. 1 and thus redundant descriptions thereof will be omitted here.

FIG. 3 is a diagram illustrating the structure of banks and channels of the storage apparatus 120 illustrated in FIGS. 1 and 2 according to exemplary embodiments of the present general inventive concept.

A plurality of channels CH1 through CHN may be electrically connected to the plurality of flash memory devices 121, 122, and 123. The channels CH1 through CHN may be independent buses to transmit and receive control signals, addresses, and data to and from the corresponding flash memory devices 121, 122, and 123. The flash memory devices 121, 122, and 123 connected to the different channels CH1 through CHN may independently operate. Each of the flash memory devices 121, 122, and 123 connected to the different channels CH1 through CHN may include a plurality of banks Bank1 through BankM. The M number of banks Bank1 through BankM formed in each channel may be connected to an M number of flash memory devices.

For example, the flash memory device 121 may include the M number of banks Bank1 through BankM in the first channel CH1. Flash memory devices 121-1 through 121-M respectively corresponding to the M number of banks Bank1 through BankM may be connected to the first channel CH1. The above-described correlations between the flash memory device 121, the M number of banks Bank1 through BankM, and the first channel CH1 may also be applied to the flash memory devices 122 and 123. Flash memory devices 121 through 123, which include the banks, may be communicatively coupled to the memory controller 110 illustrated in FIGS. 1-2 via channels CH1 through CHN.

A bank is a unit to identify flash memory devices sharing the same channel. Each flash memory device may be identified according to a channel number and a bank number. For example, the flash memory device 121 may include the M number of banks Bank1 through BankM in the first channel CH1. A channel and a bank of a flash memory device to perform a request provided from a host (e.g., host 10 illustrated FIGS. 1 and 2) may be determined based on a logical block address (LBA) transmitted from the host.

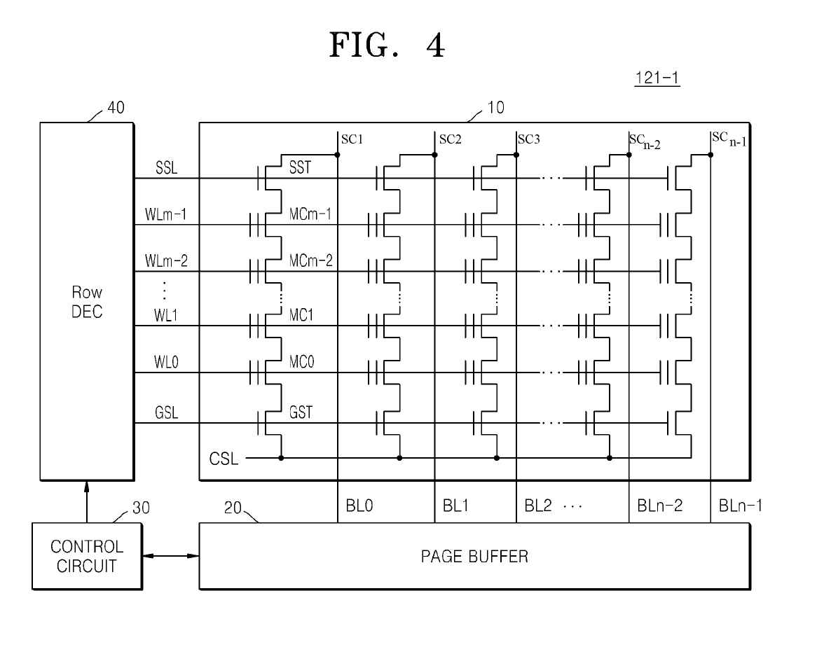

FIG. 4 is a diagram illustrating a circuit structure of the flash memory device 121-1 included in the storage apparatus 120.

As illustrated in FIG. 4, the flash memory device 121-1 may include a cell array 10, a page buffer 20, a control circuit 30, and a row decoder 40.

The cell array 10 is a region into which data is written by applying a predetermined voltage to a transistor. The cell array 10 includes memory cells formed where a plurality of word lines WL0 through WLm-1 and a plurality of bit lines BL0 through BLn-1 cross each other. In this regard, m and n are natural numbers. Although one memory block is illustrated in FIG. 4, the cell array 10 may include a plurality of memory blocks. Each memory block includes pages corresponding to the word lines WL0 through WLm-1. Each page includes a plurality of memory cells connected to each word line. The flash memory device 121-1 performs an erase operation in block units, and performs a program or read operation in page units.

The cell array 10 has a structure of cell strings. Each cell string includes a string selection transistor SST connected to a string channel (e.g., SC1, SC2, SC3, . . . , SCn-2, SCn-1, etc.), a string selection line SSL, a plurality of memory cells MC0 through MCm-1 respectively connected to the word lines WL0 through WLm-1, and a ground selection transistor GST connected to a ground selection line GSL. In this regard, the string selection transistor SST is connected between a bit line (e.g., BL0, etc.) and a string channel (e.g., SC1, SC2, SC3, . . . , SCn-2, SCn-1, etc.), and the ground selection transistor GST is connected between the string channel and a common source line CSL.

The page buffer 20 is connected to the cell array 10 via the bit lines BL0 through BLn-1. The page buffer 20 temporarily stores data to be written into or read from memory cells (e.g., memory cells MC0 through MCm-1) connected to a selected word line.

The control circuit 30 generates various voltages to perform a program or read operation, and an erase operation, and controls overall operations of the flash memory device 121-1.

The row decoder 40 is connected to the cell array 10 via the string selection line SSL, the ground selection line GSL, and the word lines WL0 through WLm-1. In the program or read operation, the row decoder 40 receives an address and selects any one word line according to the received address. In this regard, the selected word line is connected to memory cells (e.g., memory cells MC0 through MCm-1) on which the program or read operation is to be performed.

The row decoder 40 applies voltages required to perform the program or read operation, e.g., a program voltage, a pass voltage, a read voltage, a string selection voltage, and a ground selection voltage, to the selected word line, unselected word lines, the string selection line SSL, and the ground selection line GSL.

Each memory cell may store one-bit data, or two-or-more bit data. A memory cell to store one-bit data is referred to as a single level cell (SLC). A memory cell to store two-or-more-bit data is referred to as a multi level cell (MLC). An SLC has an erase or program state according to a threshold voltage.

Since the reliability of flash memory including MLCs may be reduced due to factors such as a time of use and a program/erase cycle, ECC (error correction coding) correction may be disabled. A physical page of flash memory includes a spare region. ECC information may be stored in the spare region of the flash memory (e.g., flash memory device 121, 122, or 123 illustrated in FIGS. 1-3).

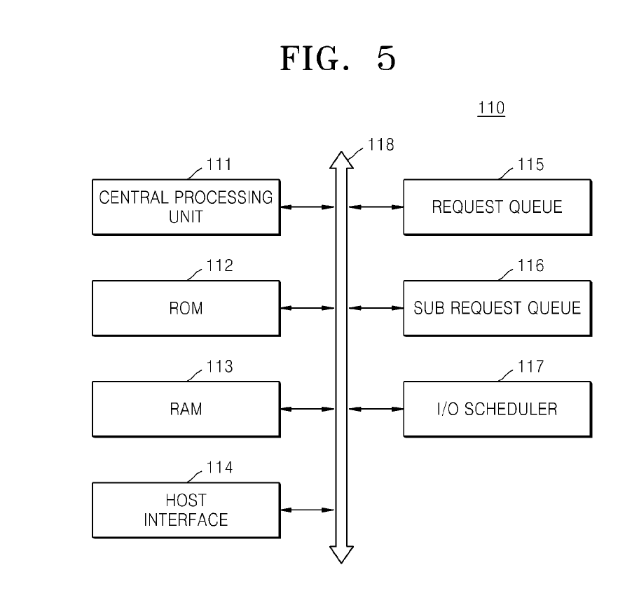

A detailed description of the memory controller 110 illustrated in FIGS. 1 and 2 will now be described with reference to FIG. 5 below.

FIG. 5 is a diagram illustrating a detailed structure of the memory controller 110 illustrated in FIGS. 1 and 2.

Referring to FIG. 5, the memory controller 110 includes a central processing unit 111, a read only memory (ROM) 112, a random access memory (RAM) 113, a host interface 114, a request queue 115, a sub request queue 116, an I/O scheduler 117, and a bus 118.

The elements of the memory controller 110 may be electrically connected to each other via the bus 118.

The host interface 114 includes a protocol to exchange data with the host 10 connected to the memory system 100′ or 100″, and interfaces the memory system 100′ or 100″ and the host device 100 to each other. The host interface 114 may be an Advanced Technology Attachment (ATA) interface, a Serial Advanced Technology Attachment (SATA) interface, a Parallel Advanced Technology Attachment (PATA) interface, a Universal Serial Bus (USB) or Serial Attached Small Computer System (SAS) interface, a Small Computer System Interface (SCSI), an embedded Multi Media Card (eMMC) interface, or a Unix File System (UFS) interface. However, the above-mentioned interfaces are merely examples and the host interface 114 is not limited thereto. The host interface 114 may transmit and receive commands, addresses, and data with the host device 100 by the control of the central processing unit 111.

The ROM 112 may store program codes and data to control operations performed in the memory system 100′ or 100″. For example, program codes to perform a memory operation timing control method illustrated in FIGS. 7 through 14 may be stored in the ROM 112. The internal memory 212 may store metadata used to map addresses.

The RAM 113 may store the program codes and data read from the ROM 112. The RAM 113 may store data received through the host interface 114 or data received from the storage apparatus 120 through the I/O scheduler 117.

The central processing unit 111 may control overall operations of the memory system 100′ or 100″ including the memory controller 110. The central processing unit 111 may be a processor, a controller, a field programmable gate array, a programmable logic device, and/or an integrated circuit to control the operations of the memory system 100′ and 100″ according to exemplary embodiments of the present general inventive concept disclosed herein.

For example, if power is applied to the memory system 100′ or 100″, the central processing unit 111 reads the program codes and data required to control operations performed in the memory system 100′ or 100″ from the ROM 112 and loads the read program codes and data to the RAM 113.

The central processing unit 111 may control overall operations of the memory system 100′ or 100″ by using the program codes and data loaded onto the RAM 113.

The request queue 115 sequentially stores one or a plurality of I/O requests received from the host device 10 (see, e.g., FIGS. 1-2) through the host interface 114. In this regard, the I/O request may be referred to as a host request. The host interface 114 may be communicatively coupled to the host illustrated in FIGS. 1 and 2. The request queue 115 may be any suitable memory device to store requests received from the host device 10.

The I/O requests stored in the request queue 115 may have standards that may not be directly processed by the storage apparatus 120 including flash memory devices.

Accordingly, the central processing unit 111 reads the I/O requests stored in the request queue 115 and splits the I/O requests into sub requests so that the storage apparatus 120 may perform an operation. The central processing unit 111 translates the sub requests into physical addresses that are recognized by the storage apparatus 120. For example, the central processing unit 111 splits the I/O requests into sub requests having standards capable of program/read operations in flash memory devices. Sizes of the sub requests may be defined as page units capable of being independently processed by flash memory devices. Logical addresses designated in the sub requests may be translated into physical addresses of flash memory devices.

The central processing unit 111 stores the above-processed sub requests in the sub request queue 116. The sub requests are units to perform operations in flash memory devices (e.g., flash memory 121-123) included in the storage apparatus 120. Thus, the sub requests may be operation issue units. The sub request queue 116 may be any suitable memory device to store sub requests (i.e., I/O requests that have been split into sub requests having standards capable of program/read operations in flash memory devices).

The sub request queue 116 may manage the sub requests for each channel (e.g., CH1, . . . , CHN). Also, the sub request queue 116 may manage the sub requests in units of flash memory devices included in the storage apparatus 120 (e.g., flash memory devices 121, 122, and 123).

When the number of flash memory devices that simultaneously perform operations in the storage apparatus 120 exceeds a reference value, a read time of the I/O requests stored in the request queue 115 may be delayed by an initially set time. That is, the read time of the I/O requests stored in the request queue 115 may be delayed by a predetermined set time. The central processing unit 111 may calculate the number of flash memory devices that simultaneously perform operations in the storage apparatus 120 for each channel or in all of the channels. For example, operation states of flash memory devices may be identified through an interrupt method or a polling method.

For example, when the number of flash memory devices that simultaneously perform operations in the memory system 100′ or 100″ for each channel exceeds a first threshold, the central processing unit 111 may delay the read time of the I/O requests stored in the request queue 115 by the initially set time (e.g., a predetermined set time).

As another example, when the number of flash memory devices that simultaneously perform operations in all of the channels of the memory system 100′ or 100″ exceeds a second threshold, the central processing unit 111 may delay the read time of the I/O requests stored in the request queue 115 by the initially set time (e.g., the predetermined set time).

When an operating temperature of the memory system 100″ detected by the temperature sensor 130 included in the memory system 100″ exceeds a threshold temperature, the central processing unit 111 may delay the read time of the I/O requests stored in the request queue 115 by the initially set time.

The I/O scheduler 117 reads the sub requests stored in the sub request queue 116 and issues operations, which correspond to the read sub requests, to be performed in designated channels and banks. The I/O scheduler 17 may be a controller, a processor, an integrated circuit, and/or any suitable device to read the sub requests stored in the sub request queue 116 and issue operations.

The I/O scheduler 117 may adjust operation timing as follows.

The I/O scheduler 117 may adjust operation timing, for example, such that the number of flash memory devices that simultaneously perform operations for each channel is below the first threshold. More specifically, the I/O scheduler 117 may adjust operation timing for each channel based on a scheduling operation of temporarily stopping issuing an operation with respect to a channel in which the number of banks that perform operations exceeds the first threshold, and resuming issuance of an operation with respect to a channel in which the number of banks that perform operations is below the first threshold.

The I/O scheduler 117 may adjust operation timing, as another example, such that the number of flash memory devices that simultaneously perform operations in all of the channels of the memory system 100′ or 100″ is below the second threshold. More specifically, the I/O scheduler 117 may adjust operation timing for each channel based on a scheduling operation of temporarily stopping issuing operations with respect to all of the channels when the number of flash memory devices that simultaneously perform operations in all of the channels of the memory system 100′ or 100″ exceeds the second threshold, and resuming issuance of operations with respect to all of the channels when the number of flash memory devices that simultaneously perform operations in all of the channels of the memory system 100′ or 100″ is below the second threshold.

In exemplary embodiments of the present general inventive concept, I/O scheduler 117 may adjust operation timing when the operating temperature of the memory system 100″ detected by the temperature sensor 130 included in the memory system 100″ exceeds the threshold temperature, and may not adjust operation timing when the operating temperature of the memory system 100″ does not exceed the threshold temperature.

In exemplary embodiments of the present general inventive concept, I/O scheduler 117 may adjust operation timing when a type of an operation to be issued to a flash memory device is a write operation, and may not to adjust operation timing when the type of the operation to be issued to the flash memory device is not the write operation. The type of the operation may be determined by an I/O type between the memory controller 110 and the storage apparatus 120.

For example, when the operating temperature of the memory system 100″ detected by the temperature sensor 130 included in the memory system 100″ exceeds the threshold temperature, the central processing unit 111 may lower the first threshold or the second threshold corresponding to the reference value used to limit the number of flash memory devices that simultaneously perform operations for each channel or in all of the channels.

The memory controller 110 may allow the central processing unit 111 to perform the above-described operating timing processing performed by the I/O scheduler 117. The memory controller 110 may allow the central processing unit 111 to perform the function of the I/O scheduler 117.

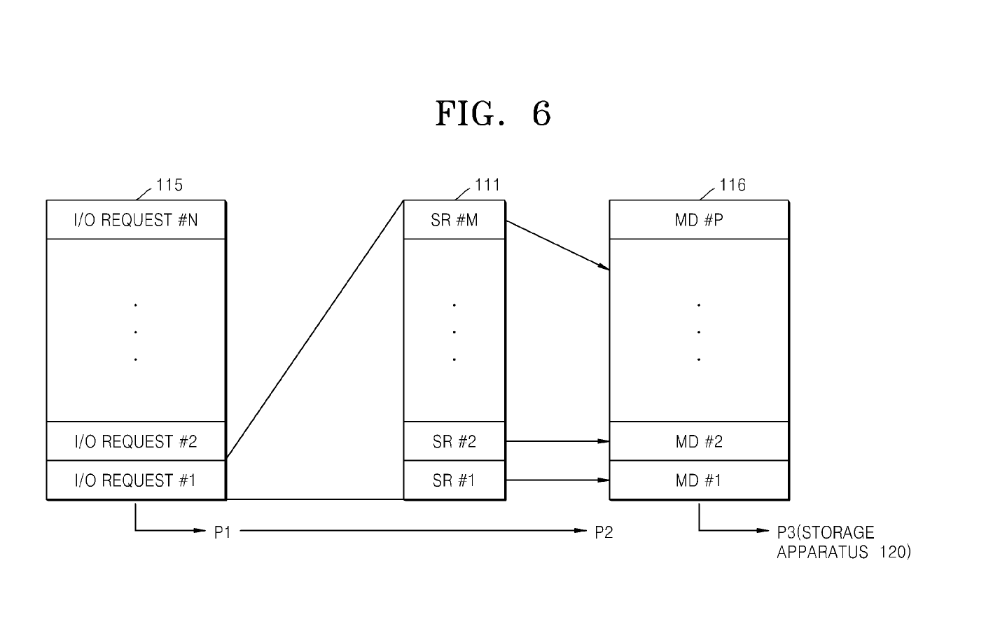

FIG. 6 is a conceptual diagram illustrating a memory operation timing control method performed by the memory controller 110 according to exemplary embodiments of the present general inventive concept.

The memory operation timing control method performed by the memory controller 110 will now be described with reference to FIG. 6.

The request queue 115 sequentially stores I/O requests received from a host (e.g., host 10 illustrated in FIGS. 1 and 2). The memory controller 110 performs the following processes in order to issue operations according to the I/O requests stored in the request queue 115 and transfer the operations to the storage apparatus 120.

The memory controller 110 performs a first process P1 of reading the I/O requests stored in the request queue 115 at an initially set time. For example, an I/O request #1 may be read in the first process P1.

The memory controller 110 performs a second process P2 of splitting the I/O requests read from request queue 115 into sub requests capable of being processed in flash memory devices included in the storage apparatus 120, performing address translation processing on the sub requests, and storing the sub requests in the sub request queue 116. For example, the I/O request #1 may be split into sub requests SR #1˜SR #M in the second process P2. The sub requests SR #1˜SR #M generated during the second process P2 may be temporarily stored in a register of the central processing unit 111. The sub request queue 116 may classify and store the sub requests SR #1˜SR #M for each of flash memory devices MD#1˜MD #P.

The memory controller 110 performs a third process P3 of issuing operations according to the sub requests read from the sub request queue 116 for each of the flash memory devices MD#1˜MD #P.

In exemplary embodiments of the present general inventive concept, the memory operation timing may be controlled by using a method of delaying a time taken to perform the first process P1 or the third process P3.

The memory operation timing control method performed by using the method of delaying a time taken to perform the first process P1 or the third process P3 by the memory controller 110 will now be described in detail with reference to FIGS. 6 through 15.

FIG. 7 is a flowchart illustrating a memory operation timing control method according to exemplary embodiments of the present general inventive concept.

In operation S101, the memory controller 110 adjusts operation timing based on the number of flash memory devices that simultaneously perform operations in the storage apparatus 120.

For example, the memory controller 110 may adjust operation timing such that the number of flash memory devices that simultaneously perform operations in the storage apparatus 120 for each channel is below a first threshold. As another example, the memory controller 110 may adjust operation timing such that the number of flash memory devices that simultaneously perform operations in all of the channels of the storage apparatus 120 is below a second threshold.

For example, the memory controller 110 may adjust operation timing by performing the first process P1 of reading I/O requests from the request queue 115. As another example, the memory controller 110 may adjust operation timing by performing the third process P3 of issuing operations according to the sub requests read from the sub request queue 116 for a flash memory device.

In operation S102, the memory controller 110 issues operations based on the operation timing adjusted in operation S101. If the operations are issued, the operations are transferred to corresponding flash memory devices (e.g., flash memory 121-123) through channels (e.g., channels CH1 through CHN) connected to the flash memory devices that are to perform the operations.

Various embodiments of the memory operation timing control method of FIG. 7 will now be described with reference to FIGS. 8 through 10.

FIG. 8 illustrates a detailed flowchart of the memory operation timing control method of FIG. 7 according to exemplary embodiments of the present general inventive concept.

In operation S201, the memory controller 110 calculates the number Ni of banks that are performing operations for each channel. The number Ni corresponds to the number of flash memory devices that simultaneously perform operations in a channel i. For example, if the number of channels is 8, the numbers of banks N1˜N8 may be calculated for each of the 8 channels. The number of channels may be singular or plural in a memory system.

In operation S202, the memory controller 110 compares the number Ni of the banks that are performing the operations for each channel with a first threshold. The first threshold TH1 may be determined in consideration of power consumption and heating values of flash memory devices with respect to the operations performed for each channel. For example, each channel may include four banks, and the first threshold TH1 may be set as 3. The number Ni of banks may be singular or plural in the memory system in various situations.

In operation S203, the memory controller 110 temporarily stops issuing operations with respect to the channel i for which the number Ni of the banks that are performing the operations exceeds the first threshold TH1, which is determined as a result of the comparison of operation S202. For example, when the first threshold TH1 is set as 3, the memory controller 110 temporarily stops issuing operations according to the third process P3 of FIG. 6 with respect to a channel for which three or more banks are simultaneously performing operations. Then, the memory controller 110 performs operation S201 again.

In operation S204, the memory controller 110 resumes issuance of operations with respect to the channel i for which the number Ni of the banks that are performing the operations is below the first threshold TH1, which is determined as a result of the comparison of operation S202. Accordingly, the memory controller 110 temporarily stops issuing operations with respect to a channel for which the number Ni of the banks that are performing the operations exceeds the first threshold TH1, and resumes issuance of operations with respect to a channel for which the number Ni of the banks that are performing the operations is below the first threshold TH1.

For example, in a case where the first threshold TH1 is set as 3, the memory controller 110 temporarily stops issuing operations according to the third process P3 of FIG. 6 with respect to a channel for which three or more banks that are simultaneously performing operations, and resumes issuance of operations according to the third process P3 of FIG. 6 with respect to a corresponding channel when one bank completely performs operations in the channel for which three or more banks are simultaneously performing operations.

FIG. 15 illustrates an exemplary operation timing diagram for when the present general inventive concept is not applied.

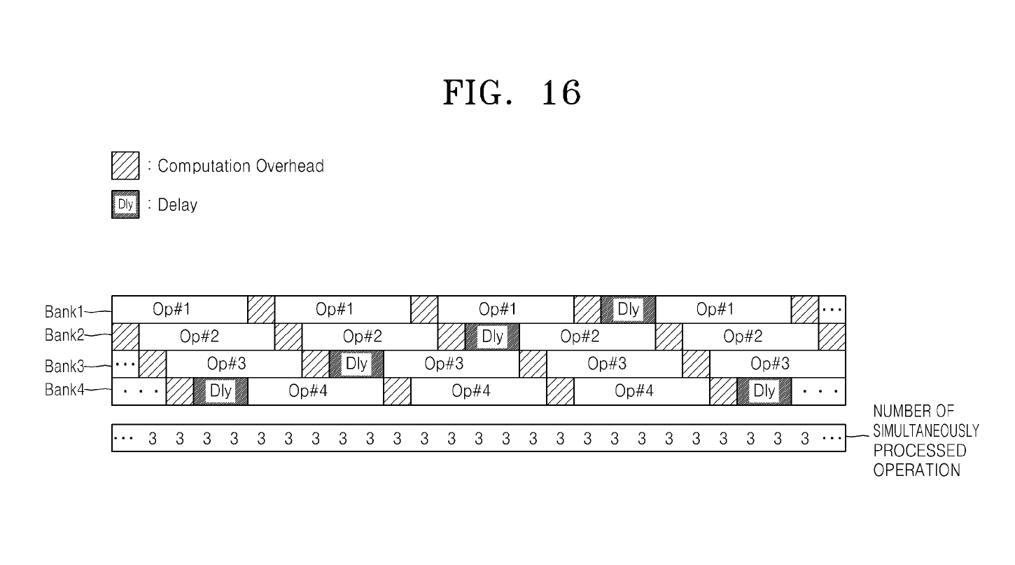

Operation timing of flash memory devices with respect to one channel for when the present general inventive concept is not applied when each channel of a memory system includes four banks is illustrated in FIG. 15. Operation timing for when the inventive concept is applied is illustrated in FIG. 16.

Referring to FIGS. 15 and 16, oblique line sections indicate computation overhead used to issue operations of the memory controller 110.

In FIG. 15, four banks Bank1˜Bank4 simultaneously perform operations in one channel during sections T1, T2, T3, and T4.

For example, if the number of banks that simultaneously perform operations for each channel is limited to 3 according to the present general inventive concept, the operation timing of FIG. 15 is changed to the operation timing of FIG. 16.

According to exemplary embodiments of the present general inventive concept of the flowchart of FIG. 8, if the number of banks that simultaneously perform operations for each channel is 3, issuance of operations for a corresponding channel is temporarily stopped, and if the number of banks that simultaneously perform operations for each channel is below 2, the issuance of operations for a corresponding channel is resumed. This results in, if the number of banks that simultaneously perform operations for each channel is 3, the issuance of operations being delayed until one bank completely performs operations for the corresponding channel.

In FIG. 16, sections in which the issuance of operations is delayed are indicated with “Dly”. A section in which the four banks Bank1˜Bank4 simultaneously perform operations in one channel does not occur in FIG. 16. In contrast, FIG. 15 illustrates where four banks Bank1˜Bank4 simultaneously perform operations in one channel. For example, as illustrated in FIG. 15, operations Op#1 through Op#4 are simultaneously performed in one channel at T1, T2, T3 and T4 (i.e., where the number of banks that simultaneously perform operations for each channel is 4).

The above-described operation in connection with FIG. 16 of limiting the number of banks that simultaneously perform operations for each channel may control the performance (e.g., the maximum performance) and a temperature increase range of a memory system. That is, the memory system may operate with the performance and heating values (e.g., the maximum performance and maximum heating values) in proportion to the number of banks that simultaneously perform operations.

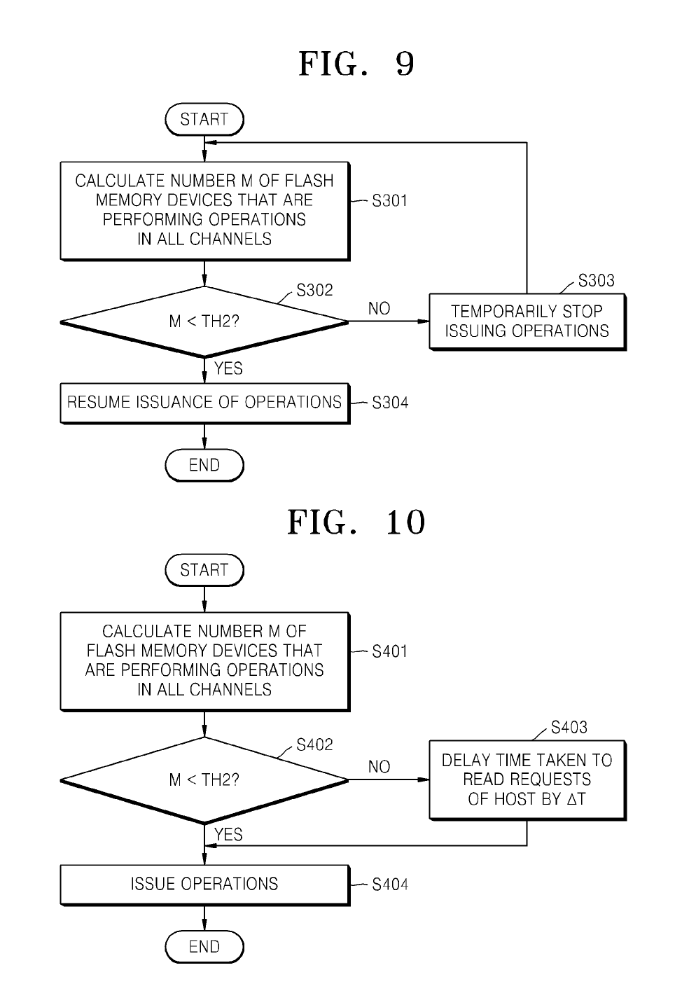

FIG. 9 illustrates a detailed flowchart of the memory operation timing control method of FIG. 7 according to exemplary embodiments of the present general inventive concept.

In operation 301, the memory controller 110 calculates the number M of flash memory devices that are performing operations in all of the channels of a memory system. For example, the number M corresponds to the number of flash memory devices that are simultaneously performing operations in 8 channels if the number of channels is 8 (e.g., channels CH1 through CH8). The number of channels in the memory system may be singular or plural in various situations.

In operation S302, the memory controller 110 compares the number M of flash memory devices that are performing operations in all of the channels with a second threshold TH2. The second threshold TH2 may be determined within a reliable range in the memory system in consideration of power consumption and heating values of flash memory devices with respect to the operations performed in all of the channels. That is, the second threshold is determined according to power consumption and heating values of flash memory devices, with respect to the operations performed in all of the channels.

In operation S303, the memory controller 110 temporarily stops issuing operations with respect to all of the channels when the number M of flash memory devices that are performing operations in all of the channels exceeds the second threshold TH2, which is determined as a result of the comparison in operation S302. Upon completion of operation S303, the memory controller 110 performs operation S301 again.

In operation S304, the memory controller 110 resumes issuance of operations with respect to the all of channels in a case where the number M of flash memory devices that are performing operations in all of the channels is below the second threshold TH2, which is determined as a result of the comparison in operation S302. Accordingly, the memory controller 110 temporarily stops issuing operations with respect to all of the channels when the number M of flash memory devices that are performing operations in all of the channels exceeds the second threshold TH2, and resumes issuance of operations with respect to all of the channels in a case where the number M of flash memory devices that are performing operations in all of the channels is below the second threshold TH2.

For example, in a case where the second threshold TH2 is set as 20, the memory controller 110 temporarily stops issuing operations according to the third process P3 of FIG. 6 with respect to all of the channels when the number M of flash memory devices that are performing operations in all of the channels exceeds 20, and resumes issuance of operations according to the third process P3 of FIG. 6 with respect to all of the channels in a case when the number M of flash memory devices that are performing operations in all of the channels is below 20.

The above-described operation of limiting the number of flash memory devices that are performing operations in all of the channels may control the maximum performance and a temperature increase range of the memory system.

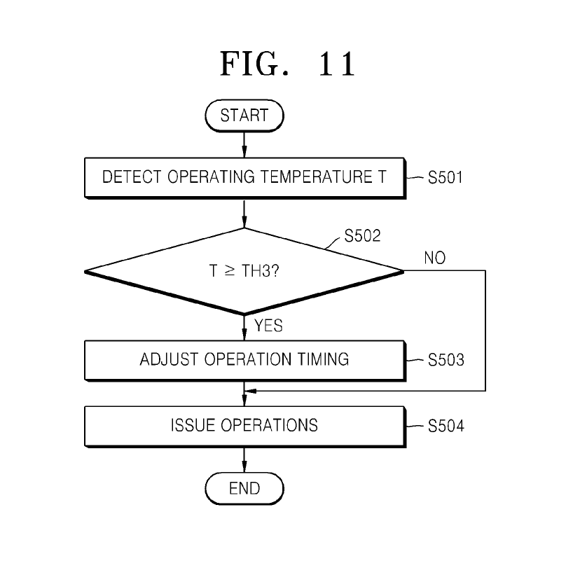

FIG. 10 is a detailed flowchart illustrating the memory operation timing control method of FIG. 7 according to exemplary embodiments of the present general inventive concept.

In operation S401, the memory controller 110 calculates the number M of flash memory devices that are simultaneously performing operations in all of the channels of a memory system.

In operation S402, the memory controller 110 compares the number M of flash memory devices that are simultaneously performing operations in all of the channels of the memory system with the second threshold TH2.

In operation S403, the memory controller 110 delays a time taken to read requests of a host (e.g., host 10 illustrated in FIGS. 1 and 2) by ΔT (i.e., a time delay) when the number M of flash memory devices that are simultaneously performing operations in all of the channels of the memory system exceeds the second threshold TH2, which is determined as a result of the comparison of operation S402. For example, referring to FIG. 6, the memory controller 110 delays a time taken to perform the first process P1 of reading the I/O requests stored in the request queue 114. Accordingly, an operation issuance time is delayed by ΔT in a request unit of the host.

In operation S404, the memory controller 110 issues operations. Accordingly, the memory controller 110 issues operations based on the requests of the host (e.g., host 10 illustrated in FIGS. 1 and 2) read from the request queue 115 at an initially set time when the number M of flash memory devices that are simultaneously performing operations in all of the channels of the memory system is below the second threshold TH2, which is determined as a result of the comparison in operation S402. The memory controller 110 issues operations based on the requests of the host read from the request queue 115 at a time delayed by ΔT with respect to the initially set time when the number M of flash memory devices that are simultaneously performing operations in all of the channels of the memory system exceeds the second threshold TH2, which is determined as a result of the comparison in operation S402.

According to the memory operation timing control operations described above, a delay time is adjusted in a request unit of the host, thereby uniformly delaying the requests of the host. Thus, maximum latency may be relatively reduced compared to a method of limiting the number of flash memory devices that simultaneously perform for each channel or in all of the channels.

A time for delaying the requests of the host may be freely set, thereby precisely controlling performance and heating values of the memory system.

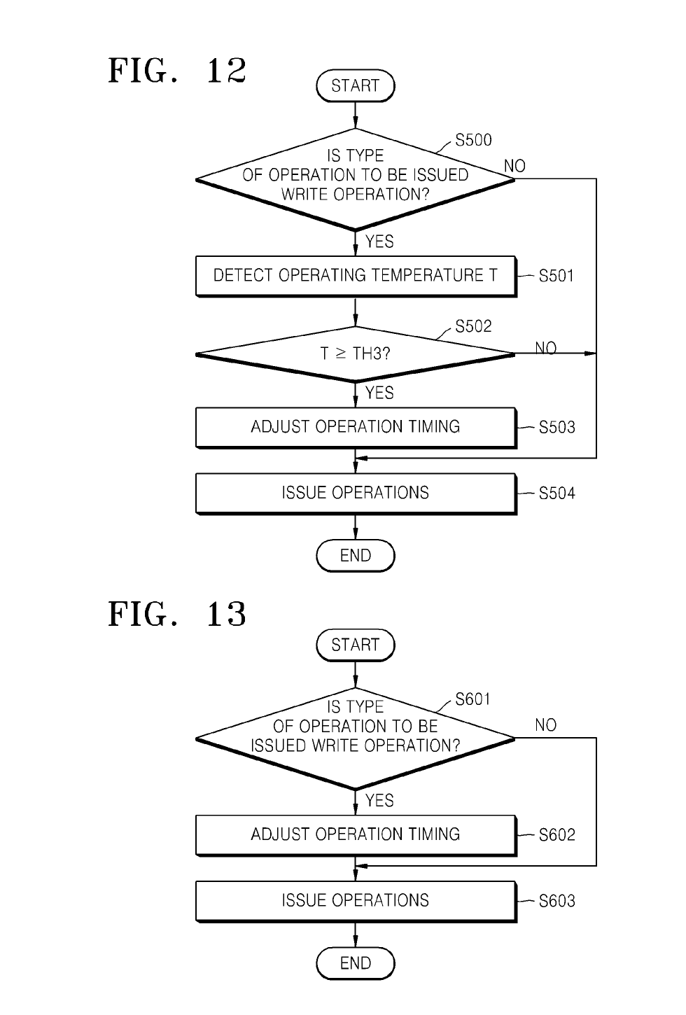

FIG. 11 is a flowchart illustrating a memory operation timing control method according to exemplary embodiments of the present general inventive concept. The memory operation timing control method of FIG. 11 may be performed by the memory system 100″ including the temperature sensor 130 of FIG. 2.

In operation S501, the memory controller 110 detects an operating temperature T of the memory system 100″ with the temperature sensor 130.

In operation S502, the memory controller 110 compares the operating temperature T detected in operation S501 with a threshold temperature TH3. For example, the threshold temperature TH3 may be determined as a temperature capable of guaranteeing quality in the memory system 100″. That is, the threshold temperature TH3 may be a maximum temperature in which the memory system 100″ may operate without error or damage.

In operation S503, when the detected operating temperature T exceeds the threshold temperature TH3, which is determined as a result of the comparison of operation S502, the memory controller 110 performs an operation timing adjustment process. Various examples of the operation timing adjustment process have been described with reference to FIGS. 8 through 10 and thus redundant descriptions thereof will be omitted here. For example, one or more operation timing adjustment processes described with reference to FIGS. 8 through 10 may be applied. For example, one operation timing adjustment process described with reference to FIG. 8 or 9 and the operation timing adjustment processes described with reference to FIG. 10 may be applied together.

When the detected operating temperature T is below the threshold temperature TH3, which is determined as a result of the comparison of operation S502, the memory controller 110 skips the operation timing adjustment process of operation S503. Accordingly, when the detected operating temperature T is below the threshold temperature TH3, which is determined as a result of the comparison in operation S502, the operation timing adjustment process of operation S503 may not be performed.

In operation S504, the memory controller 110 performs a process of issuing operations. For example, when the detected operating temperature T exceeds the threshold temperature TH3, the memory controller 110 issues operations according to the adjusted operation timing, and, when the detected operating temperature T is below the threshold temperature TH3, issues operations according to the original operation timing. In this regard, the original operation timing means initially set operation issuance timing that is not adjusted.

If the one operation timing adjustment process described with reference to FIG. 8 or 9 is applied in operation S503, the number of flash memory devices that simultaneously operate for each channel or in all of the channels is reduced (i.e., directly limited), thus improving temperature response characteristics.

When the operation timing adjustment processes described with reference to FIG. 10 are applied in operation S503, operation timing may be freely adjusted, and thus maximum latency with respect to requests of a host may be reduced.

FIG. 12 is a flowchart illustrating a memory operation timing control method according to exemplary embodiments of the present general inventive concept.

In operation S500, the memory controller 110 determines whether a type of an operation to be issued to the storage apparatus 120 is a write operation. When the storage apparatus 120 includes flash memory devices, the write operation means a program operation. For example, the type of the operation may be determined based on an I/O type between the memory controller 110 and the storage apparatus 120.

When it is determined in operation S500 that the type of the operation to be issued to the storage apparatus 120 is the write operation, the memory controller 110 detects the operating temperature T of the memory system 100″ by using the temperature sensor 130 at operation S501.

The memory controller 110 compares the operating temperature T detected in operation S501 with the threshold temperature TH3 in operation S502.

When the detected operating temperature T exceeds the threshold temperature TH3, which is determined as a result of the comparison of operation S502, the memory controller 110 performs an operation timing adjustment process in operation S503. Various examples of the operation timing adjustment process have been described with reference to FIGS. 8 through 10 and thus redundant descriptions thereof will be omitted here. For example, one or more operation timing adjustment processes described with reference to FIGS. 8 through 10 may be applied. For example, one operation timing adjustment process described with reference to FIG. 8 or 9 and the operation timing adjustment processes described with reference to FIG. 10 may be applied together.

When the detected operating temperature T is below the threshold temperature TH3, which is determined as a result of the comparison of operation S502, the memory controller 110 skips the operation timing adjustment process of operation S503. Accordingly, when the detected operating temperature T is below the threshold temperature TH3, which is determined as a result of the comparison of operation S502, the operation timing adjustment process of operation S503 may not be performed.

When it is determined in operation S500 that the type of the operation to be issued to the storage apparatus 120 is not the write operation, the memory controller 110 skips operations S501 through S503 and performs an operation issuance process in operation S504. This is because power consumption increases when the write operation is performed, which increases a heating value, whereas power consumption is relatively reduced when a read operation is performed, which does not cause a heating problem. Accordingly, when the read operation is performed in exemplary embodiments of the present general inventive concept, the operation timing adjustment process of operation S503 is skipped, which may not limit the maximum performance of the memory system 100″.

In operation S504, the memory controller 110 issues operations according to an adjusted operation timing when the detected operating temperature T exceeds the threshold temperature TH3, and issues operations according to an original operation timing when the detected operating temperature T is below the threshold temperature TH3.

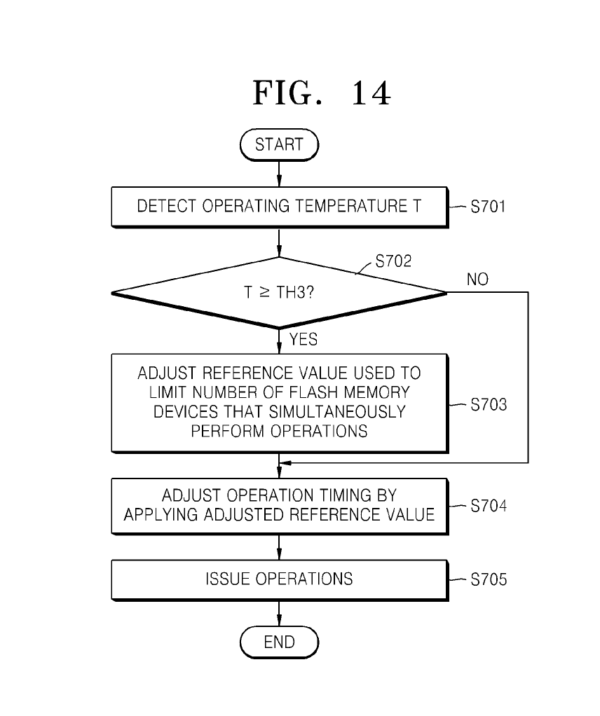

FIG. 13 is a flowchart illustrating a memory operation timing control method according to exemplary embodiments of the present general inventive concept.

The memory controller 110 determines whether a type of an operation to be issued to the storage apparatus 120 is a write operation in operation S601. When the storage apparatus 120 includes flash memory devices (e.g., flash memory devices 121, 122, and/or 123), the write operation means a program operation. For example, the type of the operation may be determined according to an I/O type between the memory controller 110 and the storage apparatus 120.

When it is determined in operation S601 that the type of the operation to be issued to the storage apparatus 120 is the write operation, the memory controller 110 performs an operation timing adjustment process in operation S602. Various examples of the operation timing adjustment process have been described with reference to FIGS. 8 through 10 and thus redundant descriptions thereof will be omitted here. For example, one or more operation timing adjustment processes described with reference to FIGS. 8 through 10 may be applied. For example, one operation timing adjustment process described with reference to FIG. 8 or 9 and the operation timing adjustment processes described with reference to FIG. 10 may be applied together.

When it is determined in operation S601 that the type of the operation to be issued to the storage apparatus 120 is not the write operation, the memory controller 110 skips the operation timing adjustment process of operation S602. Accordingly, when it is determined in operation S601 that the type of the operation to be issued to the storage apparatus 120 is not the write operation, the operation timing adjustment process of operation S602 may not be performed.

In operation S603, the memory controller 110 performs an operation issuance process. For example, the memory controller 110 issues operations according to an adjusted operation timing when the type of the operation to be issued to the storage apparatus 120 is the write operation, and issues operations according to an original operation timing in the case where the type of the operation to be issued to the storage apparatus 120 is not the write operation.

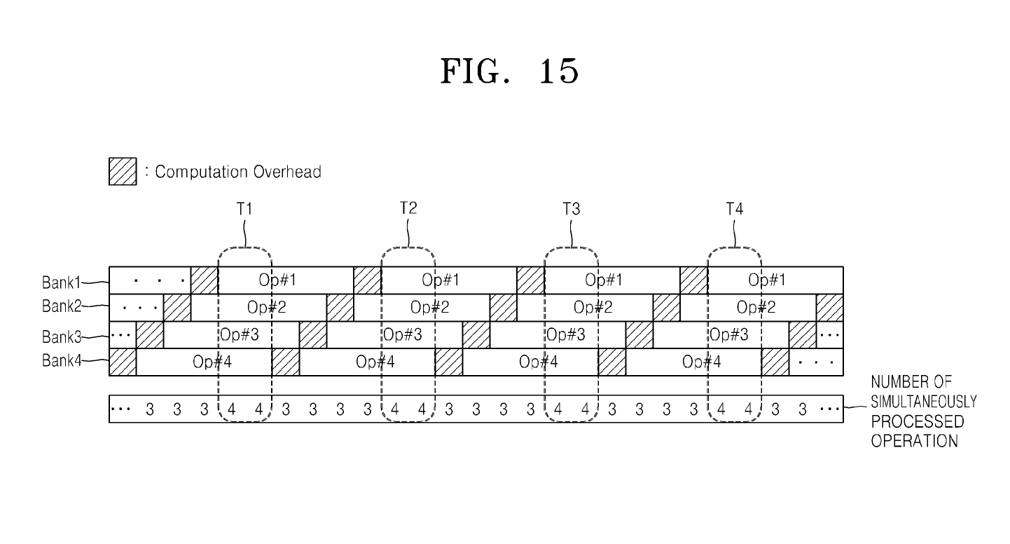

FIG. 14 is a flowchart illustrating a memory operation timing control method according to exemplary embodiments of the present general inventive concept. The memory operation timing control method of FIG. 14 may be performed by the memory system 100″ including the temperature sensor 130 of FIG. 2.

In operation S701, the memory controller 110 detects the operating temperature T of the memory system 100″ by using the temperature sensor 130.

The memory controller 110 compares the operating temperature T detected in operation S701 with the threshold temperature TH3 in operation S702.

When the detected operating temperature T exceeds the threshold temperature TH3, which is determined as a result of the comparison of operation S702, the memory controller 110 adjusts a reference value to limit the number of flash memory devices that simultaneously perform operations in the storage apparatus 120 in operation S703. For example, the first threshold TH1 to limit the number of flash memory devices that simultaneously perform operations in the storage apparatus 120 for each channel may be reduced by an initially set value. For another example, the second threshold TH2 to limit the number of flash memory devices that simultaneously perform operations in the storage apparatus 120 in all of the channels may be reduced by the initially set value.

When the detected operating temperature T is below the threshold temperature TH3, which is determined as a result of the comparison of operation S702, the memory controller 110 skips the operation timing adjustment process of operation S703.

In operation S704, the memory controller 110 performs an operation timing adjustment process by applying the adjusted reference value. Various examples of the operation timing adjustment process have been described with reference to FIGS. 8 through 10 and thus redundant descriptions thereof will be omitted here. For example, one or more operation timing adjustment processes described with reference to FIGS. 8 through 10 may be applied. For example, one operation timing adjustment process described with reference to FIG. 8 or 9 and the operation timing adjustment processes described with reference to FIG. 10 may be applied together.

In operation S705, the memory controller 110 performs a process of issuing operations.

In exemplary embodiments of the present general inventive concept, the reference value used to limit the number of flash memory devices that simultaneously perform operations for each channel or in all of the channels may be changed according to the operating temperature T of the memory system 100″. Accordingly, memory operation timing may be dynamically controlled so that the memory system 100″ may operate within a quality guarantee temperature range.

FIG. 17 is a block diagram illustrating an example of an electronic apparatus 1000 including a SSD 100 according to exemplary embodiments of the present general inventive concept.

Referring to FIG. 17, the electronic apparatus 1000 includes a central processing unit (CPU) 220, a RAM 230, a user interface (UI) 240, an application chipset 250, and the SSD 100 that are electrically connected via a bus 210.

The electronic apparatus 1000 may include a computing system such as a notebook, a personal computer (PC), a tablet computer, etc. The electronic apparatus 1000 may also include a personal digital assistant (PDA), a digital camera, a game console, a portable digital media player, a smartphone, etc.

The CPU 220 may be a processor, a controller, a field programmable gate array, a programmable logic device, and/or an integrated circuit to control the operations of the electronic apparatus 1000 according to exemplary embodiments of the present general inventive concept disclosed herein. The UI 240 may include a keypad, a display, a touchscreen, a mouse, any combination thereof, and/or one or more of any suitable devices to receive input and display output to a user. The application chipset 250 may perform and/or control one or more operations of the electronic apparatus 1000.

For example, if the electronic apparatus 1000 is a digital camera, the application chipset 250 may include one or more integrated circuits to provide color correction, sharpening, blur reduction, motion stabilization, autofocus, zoom control, and/or any other applications for the digital camera. If the electronic apparatus 1000 is a portable digital media player, the application chipset may include one or more integrated circuits to perform audio decoding and/or audio effects processing. If the electronic apparatus 1000 is a game console, the application chipset 250 may include one or more integrated circuits to perform graphic image processing and/or rendering. If the electronic apparatus 1000 is a smart phone, the application chipset 250 may include one or more integrated circuits to provide near field communication (NFC), encoding and decoding of voice, text, and/or data transmitted or received via a cellular communications network and/or wi-fi communications network, etc.

The electronic apparatus 1000 includes the SSD 100 according to exemplary embodiments of the present general inventive concept that may replace a mass storage apparatus such as a hard disk drive, etc. The memory system 100′ or 100″ of FIG. 1 or 2 may be applied to the SSD 100.

FIG. 18 is a block diagram illustrating another example of an electronic apparatus 2000 including the SSD 100 according to exemplary embodiments of the present general inventive concept.

Referring to FIG. 18, the electronic apparatus 2000 may include a mobile apparatus such as a cellular phone, a smart phone, etc., or a tablet PC, etc.

The electronic apparatus 2000 includes the SSD 100, a processor 310, a wireless transceiver 320, an input unit 330, a display 340, and an antenna 350.

The memory system 100′ or 100″ of FIG. 1 or 2 may be applied to the SSD 100.

The wireless transceiver 320 may transmit or receive a wireless signal to or from a base station via the antenna 350. The wireless transceiver 320 may convert the received wireless signals into a signal capable of being processed by the processor 310.

The processor 310 controls one or more operations of the electronic apparatus 2000. The processor 310 may process the signal output from the wireless transceiver 320 and store the processed signal in the SSD 100 or output the processed signal through the display 340.

The input unit 330 is an apparatus to receive an input and generate a control signal corresponding to the input to control an operation of the processor 310 or data to be processed by the processor 310. The input unit 330 may be a touch pad, a mouse, a key pad, or a key board.

FIG. 19 is a block diagram illustrating an example of a network system 3000 including the SSD 100 according to exemplary embodiments of the present general inventive concept.

Referring to FIG. 19, the network system 3000 may include the server system 400 and a plurality of terminals 500_1 through 500_n connected over a network. The network may be a wired and/or wireless communications network. The server system 3000 according to exemplary embodiments of the present general inventive concept may include a server 410 to process requests received from the terminals 500_1 through 500_n connected to the network, and the SSD 100 to store data corresponding to the requests received from the terminals 500_1 through 500_n. In this regard, the memory system 100′ or 100″ of FIG. 1 or 2 may be applied to the SSD 100.

The above-described memory system according to the present general inventive concept may be mounted by using various types of packages, e.g., a package on package (POP), a ball grid array (BGA), a chip scale package (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small-outline integrated circuit (SOIC), a shrink small outline package (SSOP), a thin small outline package (TSOP), a system in package (SIP), a multi chip package (MCP), a wafer-level fabricated package (WFP), and a wafer-level processed stack package (WSP).

While the present general inventive concept has been particularly illustrated and described with reference to exemplary embodiments thereof, terms used herein to describe the inventive concept are for descriptive purposes only and are not intended to limit the scope of the inventive concept. Accordingly, it will be understood by one of ordinary skill in the art that various changes in form and details may be made herein without departing from the spirit and scope of the following claims.

What is claimed is:

1. A memory operation timing control method comprising:
adjusting operation timing such that a number of memory devices that simultaneously perform operations is below a reference value according to a host request; and
issuing operations according to the adjusted operation timing and transferring the issued operations to the memory devices.

2. The memory operation timing control method of claim 1, wherein the operation timing is adjusted such that the number of the memory devices that simultaneously perform the operations for each of a plurality of channels is below a first threshold.

3. The memory operation timing control method of claim 1, wherein the operation timing is adjusted such that the number of the memory devices that simultaneously perform the operations in all of a plurality of channels is below a second threshold.

4. The memory operation timing control method of claim 1, further comprising:
splitting the operations of the host request into one or more sub requests to have sizes capable of being processed by the memory devices.

5. The memory operation timing control method of claim 1, wherein the adjusting of the operation timing comprises:
temporarily stopping the issuing of the operations with respect to a channel of the plurality of channels in which a number of banks of a plurality of banks that are performing operations exceeds a first threshold; and
resuming the issuing of the operations with respect to a channel of the plurality of channels in which the number of the banks that are performing the operations is below the first threshold.

6. The memory operation timing control method of claim 1, wherein the adjusting of the operation timing comprises:
temporarily stopping the issuing of the operations with respect to all of the channels in which a number of memory devices that are performing operations exceeds a threshold; and
resuming the issuing of the operations with respect to all of the channels in which the number of memory devices that are performing the operations is below the threshold.

7. The memory operation timing control method of claim 1, wherein the adjusting of the operation timing comprises:
delaying a time taken to read the host request by an initially set time when the number of the memory devices that simultaneously perform the operations exceeds the reference value; and
issuing operations based on the read host request according to the delayed time.

8. The memory operation timing control method of claim 1, further comprising:
detecting a temperature of a storage apparatus that includes the memory devices,
wherein the operation timing is adjusted according to the detected temperature.

9. The memory operation timing control method of claim 8, wherein, when the detected temperature exceeds a threshold temperature, a time taken to read the host request is delayed by an initially set time, and operations are issued based on the read host request according to the delayed time.

10. The memory operation timing control method of claim 8, wherein, when the detected temperature exceeds the threshold temperature, the operation timing is adjusted based on a scheduling operation of delaying the time taken to read the host request by an initially set time and a scheduling operation of limiting the number of the memory devices that simultaneously perform the operations is below a first threshold.

11. The memory operation timing control method of claim 8, further comprising:
when the detected temperature exceeds the threshold temperature, reducing the reference value.

12. The memory operation timing control method of claim 8, wherein, when the detected temperature exceeds a threshold temperature, a time taken to perform a write operation according to a host request is adjusted, and operations are issued based on the write host request according to the adjusted time.

13. The memory operation timing control method of claim 6, wherein, when the detected temperature exceeds the threshold temperature, the operation timing is adjusted based on a scheduling operation of adjusting the time taken to perform a write operation according to the host request by an initially set time and a scheduling operation of limiting the number of the memory devices that simultaneously perform the operations is below a first threshold.

14. The memory operation timing control method of claim 1, further comprising:
determining types of the operations to be issued to the memory devices,
wherein the operation timing is adjusted when the determined types of the operations are write operations.

15. A memory system comprising:
memory devices including one or more channels and one or more banks; and
a memory controller to issue operations to control the memory devices according to a request received from a host,
wherein the memory controller adjusts operation timing such that the number of memory devices that simultaneously perform operations is below a reference value.

16. The memory system of claim 15, wherein the memory controller adjusts the operation timing such that the number of the memory devices that simultaneously perform the operations for each channel is below a first threshold.

17. The memory system of claim 15, further comprising:
a temperature sensor to detect an operating temperature,
wherein the memory controller performs at least one of a process of delaying a time taken to read a request by an initially set time when the temperature detected by the temperature sensor exceeds a threshold temperature and a process of adjusting the operation timing such that the number of the memory devices that simultaneously perform the operations for each channel is below the first threshold.

18. The memory system of claim 15, wherein the memory controller adjusts the operation timing when types of the operations to be issued to the memory devices are write operations, and does not adjust the operation timing when types of the operations to be issued to the memory devices are not write operations.

19. A method of controlling a storage device having a plurality of memory devices, the method comprising:
adjusting the timing of a plurality of operations performed by a memory controller of the storage device such that a number of the plurality of memory devices of the storage device that simultaneously perform the plurality of operations is below a predetermined value;
issuing a plurality of time-adjusted operations with the memory controller according to the adjusted operation timing, where a number of issued time-adjusted operations correspond to the plurality of operations; and
transferring the issued plurality of time-adjusted operations to the plurality of memory devices.
